(19) United States
(12) Patent Application Publication
(10) Pub. No.: US 2015/0239724 A1
(43) Pub. Date: Aug. 27, 2015

(54) SYSTEM AND METHOD FOR DISPLAYING REAL-TIME INFORMATION FOR A DISPENSED ITEM

(71) Applicant: Aullor, LLC, Santa Monica, CA (US)

(72) Inventor: John Steven Cronise, Marina del Rey, CA (US)

(21) Appl. No.: 14/629,949

(22) Filed: Feb. 24, 2015

Related U.S. Application Data
(60) Provisional application No. 61/943,899, filed on Feb. 24, 2014.

(51) Int. Cl. B67D 1/08

(52) U.S. Cl. CPC B67D 1/08

(57) ABSTRACT

A system that tracks and communicates product nutrition information for a beverage dispenser, such as a self-service soda dispenser, the system configured to display nutritional information to a user based on a dispensed quantity of soda or other selected beverage. The system includes a flow rate sensor in communication with a syrup container to measure an amount of dispensed syrup used to create the beverage. A controller or processor in communication with the sensor receives information from the sensor relating to the measured quantity of syrup and calculates nutritional information, such as calories, sugar, sodium, carbohydrates, and caffeine contained in the dispensed beverage. The nutritional information is communicated to a display for presentation to the user. In some embodiments, the display may also present alternate available drinks that may be healthier (e.g., lower in calories) for comparison purposes.

### RELATED APPLICATIONS DATA

This application claims the benefit of priority under 35 U.S.C. §119(e) from U.S. Provisional Patent Application No. 61/943,899 filed on Feb. 24, 2014, the disclosure of which is incorporated herein by reference.

### TECHNICAL FIELD

The field of this disclosure relates generally to beverage dispensing systems, such as a soda fountain and, in particular, to such dispensing systems configured to display real-time information relating to a dispensed item.

### BACKGROUND

Conventional beverage dispensers typically dispense carbonated and/or non-carbonated beverages based on a user's selection. These systems may be found in various locations, such as restaurants, concession stands, convenience stores, offices, home systems, and shopping centers, for example. In operation, beverage dispensers typically combine a flavored syrup or syrup concentrate with a diluting agent, such as carbonated water or plain water in non-carbonated drinks, to create a beverage for consumption by the user. In many cases, since water is one of two primary ingredients in many of these beverages, the selection of beverages available for a user's consumption may only be limited by the number of different flavored syrups that the dispenser can accommodate. This versatility allows a retailer or other venue to offer a variety of beverages and soft drinks without having to stock pre-packaged drinks, such as soda cans and bottles, that may occupy a comparatively larger space than a conventional beverage dispenser.

The present inventor, however, has identified certain disadvantages and limitations of such dispensing systems. Unlike a pre-packaged beverage, which typically contains nutritional information (e.g., calories, sugar, carbohydrates, caffeine, and/or sodium content) affixed to or printed on the packaging, a dispensing system typically does not communicate any nutritional information to a consumer for a selected beverage. One reason for this lack of information is that many of these dispensing systems operate in a self-service environment where the user is able to obtain as much or as little of a beverage as desired (i.e., the user is not limited to obtaining a fixed quantity of a selected beverage). Another reason for this lack of information may be that a user can mix multiple beverages together (such as ⅓ diet cola and ⅔ regular cola) and the beverage system may not be able to calculate nutritional information for such mixed drinks. In such cases, the user typically is unable to determine a dispensed quantity of a selected beverage, and perhaps more importantly, the user has no nutritional information relating to the dispensed beverage. For many users, such as those that may wish to track daily caloric intake, are on a diet, or simply wish to know how many calories are being consumed for a given meal, the lack of information may be problematic. Accordingly, the present inventor has identified a need for a dispensing system capable of measuring a quantity of a dispensed beverage, and displaying real-time nutritional information to a consumer based on the measured quantity of the dispensed beverage.

Additional aspects and advantages will be apparent from the following detailed description of preferred embodiments, which proceeds with reference to the accompanying drawings.

### BRIEF DESCRIPTION OF THE DRAWINGS

FIG. 1 is a schematic diagram illustrating a real-time consumption system according to one embodiment.

FIG. 2 is a schematic diagram illustrating a real-time consumption system according to another embodiment.

FIG. 3 illustrates an example graphical user interface of a display of the consumption system of FIG. 1.

FIG. 4 illustrates another example graphical user interface of the display.

FIG. 5 illustrates yet another example graphical user interface of the display.

FIG. 6 is a flowchart of a process performed by the real-time consumption system according to one embodiment.

### DETAILED DESCRIPTION OF PREFERRED EMBODIMENTS

With reference to the drawings, this section describes particular embodiments of a consumption system and their detailed construction and operation. Throughout the specification, reference to “one embodiment,” “an embodiment,” or “some embodiments” means that a particular described feature, structure, or characteristic may be included in at least one embodiment of the consumption system. Thus appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like.

In the following description of the figures and any example embodiments, the description may refer to a self-service soda fountain (including a soda beverage dispensing gun) as an example of a conventional dispensing machine, and may refer to a soda or a soft drink as an example of a beverage dispensed by the machine. It should be understood that these particular references are merely examples and should not be considered as limiting. In other embodiments, the dispensing machine may be any other machine configured to dispense a desired amount of any item.

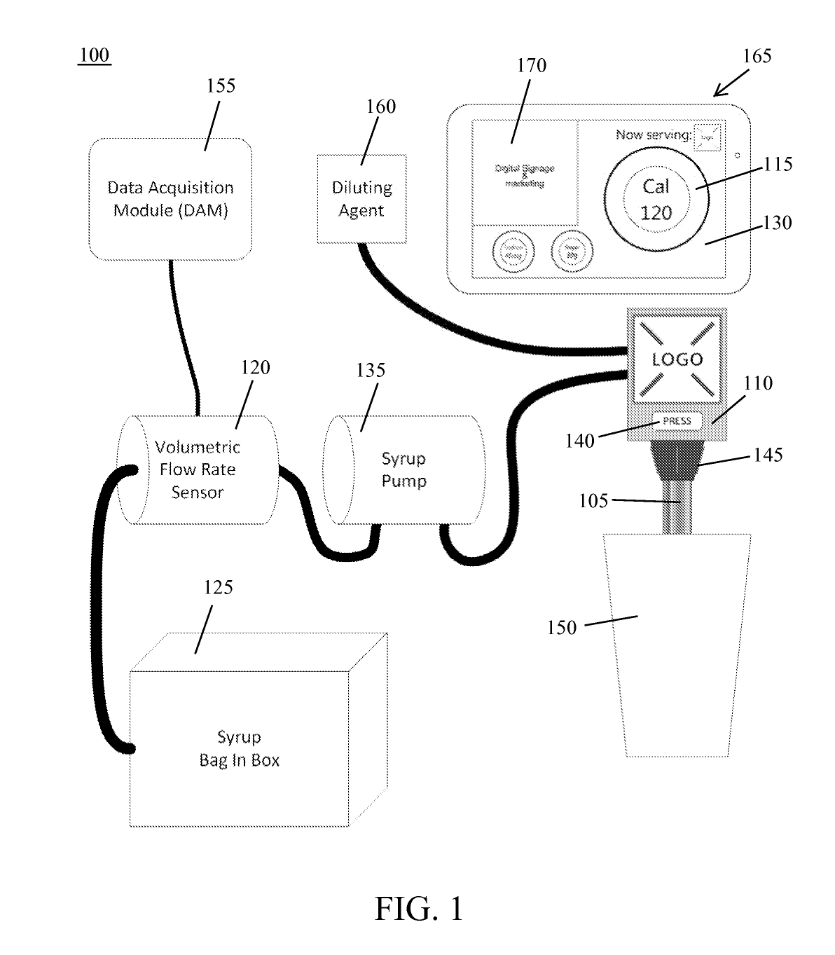

FIGS. 1-6 collectively illustrate various embodiments and features of a real-time consumption system 100 designed to measure a dispensed amount of a product or beverage 105, such as for a self-service soda fountain 110, and display nutritional information 115 (e.g., calories, sodium, sugar, carbohydrates, caffeine etc.) based on a measured amount of the beverage 105 dispensed. The nutritional information 115 allows the user to make informed decisions about the amount and type of beverage 105 to consume and/or track caloric intake on a daily or a per-meal basis. As is further detailed in the following sections, the system 100 includes a volumetric flow rate sensor 120 in communication with a syrup container or reservoir 125 to measure a volume of dispensed syrup (or syrup concentrate) used to produce the beverage 105. Based on the measured volume of syrup, the system 100 calculates the nutritional information 115 for the dispensed beverage 105 and displays the nutritional information 115 for the user's review on a display 130.

With particular reference to FIG. 1, in an example operation, a user selects a beverage 105 for consumption from a soda fountain 110 and places a cup or other container 150 underneath an output or nozzle 145. In response to the user's selection, a syrup pump 135 is activated and draws syrup out from the syrup reservoir 125 to produce the selected beverage 105. As the syrup is drawn from the syrup reservoir 125, the volumetric flow rate sensor 120 is engaged and generates an electrical pulse based on a volume of syrup drawn from the reservoir 125. For example, for every liter (L) of syrup (or syrup concentrate) dispensed to produce the beverage 105, the volumetric flow rate sensor 120 generates 450 electrical pulses. It should be understood that in other embodiments, the volumetric flow rate sensor 120 may generate a different number of electrical pulses to represent a different volume of syrup. In other embodiments, the flow rate sensor 120 may represent a volume of syrup drawn from the reservoir 125 via other suitable means. For example, the flow rate sensor 120 may generate a resistant value, a capacitance value, or a voltage to represent the volume of syrup. In still other embodiments, the sensor 120 may instead be a smart sensor that communicates information digitally (e.g., the sensor may include a microcontroller that communicates measurement values over a serial com or other network).

The total number of pulses from the flow rate sensor 120 are tallied and stored on a data acquisition module (DAM) 155. DAM 155 thereafter wirelessly communicates the pulse count tally to an electronic device 165, such as a tablet, computer, of other data terminal. Based on a predetermined conversion factor for the specific syrup used and the total number of pulses generated by the flow rate sensor 120, the electronic device 165 calculates the nutritional information 115 of the dispensed beverage 105. The calculated nutritional information 115 is thereafter presented to a user via an electronic display 130, which may be integrated as part of the electronic device 165 or may be a separate component. The following description proceeds with additional details of this and other embodiments of the real-time consumption system 100.

FIG. 1 is schematic diagram illustrating an example embodiment of a real-time consumption system 100. With particular reference to FIG. 1, the system 100 includes a syrup reservoir 125, such as a bladder or a bag-in-box package, for storing syrup or syrup concentrate used to produce a selected beverage 105. For simplicity, FIG. 1 illustrates a single syrup reservoir 125, but it should be understood that in other embodiments, the system 100 may include any number of reservoirs 125 with different syrup flavors (e.g., one each to produce a unique beverage) to offer a user a variety of beverage selections. The syrup may be drawn from the syrup reservoir 125 by a syrup pump 135 that is operated in response to actuation of the soda fountain 110, such as by depressing the button 140 or actuating another input mechanism (e.g., selecting a beverage 105 on an electronic touchscreen display). The syrup pump 135 may be a positive displacement pump, peristaltic pump, gas-driven diaphragm pump, or any other pump suitable for drawing syrup from the syrup reservoir 125. After the button 140 is depressed, a predetermined ratio of concentrated syrup from the reservoir 125 is mixed with a diluting agent, such as carbonated water or plain water stored in a second reservoir 160 (which may include a municipal water supply), such as carbonated water or plain water, and the resulting beverage 105 is dispensed to the user via an output or nozzle 145.

As mentioned previously, the system 100 includes a volumetric flow rate sensor 120 in communication with the syrup reservoir 125 to measure a volume of syrup that was drawn from the reservoir 125 and used to create the beverage 105. The sensor 120 senses an amount of syrup passing through a hose or other conduit that carries the syrup from the reservoir 125 toward the nozzle 145. As mentioned previously, the flow rate sensor 120 generates an electrical pulse for a predetermined volume of syrup that is sensed by the flow rate sensor 120 and the total number of pulses are counted by DAM 155. Based on the information from the sensor 120, the electronic device 165 calculates nutritional information 115 for the dispensed beverage 105. Although some embodiments describe that the electronic device 165 calculates nutritional information 115 based on the pulse count tally communicated by DAM 155, it should be understood that in other embodiments, DAM 155 may calculate the nutritional information 115 and then wirelessly communicate the calculated data to the electronic device 165 for presentation to the user via the electronic display 130.

In one embodiment, electronic device 165 (or DAM 155) may use the following equations to calculate the nutritional information 115, such as calories, sodium, and sugar. It should also be understood that calories, sodium, and sugar are merely some examples of nutritional information 115 that may be calculated and displayed. In other embodiments, other nutritional information 115 may be calculated, such as fat, carbohydrates, caffeine, or any other desired nutritional data. It should also be understood that these equations are merely for illustration purposes and that in other embodiments of the system 100, different or modified versions of similar equations may be used to calculate the nutritional information 115.

To calculate caloric content, the following equation may be used:

$$Calories = ( ( ( \frac{[ PulseCount ]}{[ PulsePerLiter ]} ) \times [ MixRatio ] ) \div [ ServingSize ] ) \times [ CaloriesPerServing ]$$

where PulseCount is the number of pulses generated by the volumetric flow rate sensor 120 to determine the amount of syrup used in the beverage 105, PulsePerLiter is the total number of pulses of syrup in one liter of dispensed beverage 105, MixRatio is the concentrate mixture ratio of syrup used to produce the beverage 105, ServingSize is the number of liters in one serving of beverage 105, and CaloriesPerServing are the calories in one serving of the beverage 105.

To calculate sodium content, the following equation may be used:

$$Sodium = ( ( ( \frac{[ PulseCount ]}{[ PulsePerLiter ]} ) \times [ MixRatio ] ) \div [ ServingSize ] ) \times [ SodiumPerServing ]$$

where PulseCount is the number of pulses generated by the volumetric flow rate sensor 120 to determine the amount of syrup used in the beverage 105, PulsePerLiter is the total number of pulses of syrup in one liter of dispensed beverage 105, MixRatio is the concentrate mixture ratio of syrup used to produce the beverage 105, ServingSize is the number of liters in one serving of beverage 105, and SodiumPerServing is the sodium in one serving of the beverage 105.

To calculate sugar content, the following equation may be used:

$$Sugar = ( ( ( \frac{[ PulseCount ]}{[ PulsePerLiter ]} ) \times [ MixRatio ] ) \div [ ServingSize ] ) \times [ SugarPerServing ]$$

where PulseCount is the number of pulses generated by the volumetric flow rate sensor 120 to determine the amount of syrup used in the beverage 105, PulsePerLiter is the total number of pulses of syrup in one liter of dispensed beverage 105, MixRatio is the concentrate mixture ratio of syrup used to produce the beverage 105, ServingSize is the number of liters in one serving of beverage 105, and SugarPerServing is the sugar in one serving of the beverage 105.

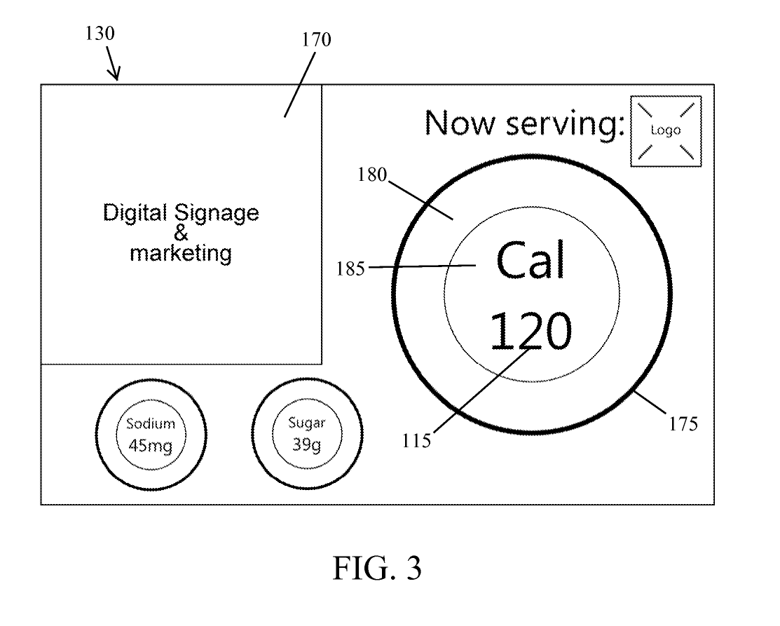

After DAM 155 has calculated the nutritional information 115 for the dispensed beverage 105, DAM 155 communicates/transmits the data to an electronic device 165. Preferably, DAM 155 transmits the data wirelessly to the electronic device 165. In other embodiments, however, DAM 155 and electronic device 165 may be hardwired. After receiving the nutritional information 115 (and any other data), the device 165 processes the data for display to the user via the electronic display 130. In other embodiments as mentioned previously, electronic device 165 may instead calculate the nutritional information 115 based on the tally count received from DAM 155 and present the data to the user via the electronic display 130. Additional information regarding the display 130 and marketing window 170 are described in further detail below with particular reference to FIG. 3.

In the embodiment illustrated and described in FIG. 1, the volumetric flow rate sensor 120 is positioned between the syrup reservoir 125 and the syrup pump 135. In the illustrated example, the flow rate sensor 120 measures the volume of syrup from the low-pressure side of the system, which helps avoid reading errors due to expansion and contraction of the syrup delivery lines (e.g., hoses) as compared to the high-pressure side of the system adjacent the soda fountain 110.

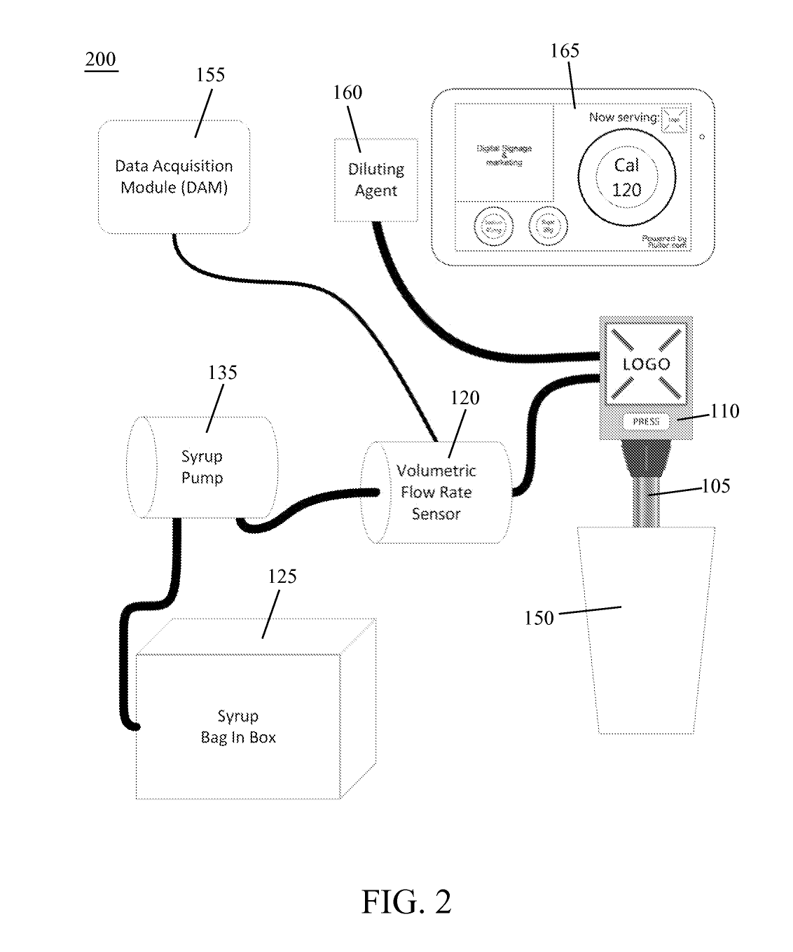

In other embodiments, such as the embodiment illustrated in FIG. 2, the flow rate sensor 120 may be positioned on the high-pressure side of the system between the syrup pump 135 and the soda fountain 110, preferably adjacent to the soda fountain 110. This configuration may be advantageous in systems where expansion and contraction of the syrup delivery lines may cause some syrup to remain in the delivery lines and consequently not used in the beverage 105, or where syrup is dispensed but the pressure drop in the syrup lines does not activate syrup pump 135. In such cases, because some syrup is being stored in the delivery lines, a flow rate sensor 120 positioned on the low-pressure side would overshoot the amount of syrup, and by extension, overshoot the nutritional information 115 contained in the dispensed beverage 105. Positioning the flow rate sensor 120 adjacent the soda fountain 110 on the high-pressure side may help eliminate or reduce calculation inaccuracies stemming from stored syrup in the delivery lines.

It is noted that the system 200 illustrated in FIG. 2 may include identical or substantially similar components as the system 100 illustrated in FIG. 1 with like reference numerals being used for like components. Accordingly, to avoid repetition, particular details of the system 200 are not further described herein.

FIG. 3 illustrates an example graphical user interface of the display 130 of the system 100 of FIG. 1. As mentioned previously, the display 130 presents nutritional information 115 relating to the dispensed beverage 105 to the user. In one embodiment, the display 130 may present the nutritional information 115 to the user both graphically and numerically via a color dial gauge 175. In one embodiment, the numerical information may be displayed in a centered readout 185 of the dial gauge 175, to indicate the calculated value for calories, sugar, and sodium contained in dispensed beverage 105. It should be understood that while FIG. 3 illustrates a circular dial gauge 175, in other embodiments, the dial gauge 175 may be depicted differently, such as by using a progress bar, a cup graphic being filled, or any other suitable graphical representation. To avoid confusion, the following section continues with the description of the dial gauge 175 as illustrated in FIG. 3, but it should be understood that the same function may be accomplished using any other suitable graphical icon.

The dial gauge 175 may include a border 180 encircling the readout 185 (such as a caloric readout illustrated in FIG. 3) for displaying the calculated values graphically. In one embodiment, the border 180 may represent a target or total recommended daily intake for a given variable. For example, the dial gauge 175 for calories may be based on a 2,000 calorie diet and portions of the border 180 may be illuminated to represent the percentage of calories being consumed based on a 2,000 calorie diet. For example, as illustrated in FIG. 3, the beverage 105 selected by the user contains 120 calories. Accordingly, for this example, the dial gauge 175 displays that calculated value numerically via the readout 185, and may also display that value graphically by illuminating a 6% portion of the border 180 to communicate to the user that the beverage 105 represents 6% of the user's daily allotted calories. In such a configuration, the display 130 presents a graphical representation to the user of the caloric intake for the dispensed beverage 105 along with a numerical value.

In another example, the dial gauge 175 for calories may be based on the syrup manufacturer's suggested serving size or volume (i.e., calories per serving size), and portions of the border 180 may be illuminated to represent the percentage of beverage dispensed as compared to the suggested serving volume. For example, with reference to FIG. 3, the beverage 105 dispensed for the user contains 120 calories. In this example, the full serving size may have a total of 200 calories, which means the user dispensed only 60% of the suggested serving size. Accordingly, the dial gauge 175 displays that value graphically by illuminating a 60% portion of the border 180 to communicate to the user that the dispensed amount of beverage 105 represents 60% of the serving size.

As mentioned previously, DAM 155 processes the data received from the volumetric flow rate sensor 120 and transmits the pulse count to the electronic device 165 for calculation and presentation of the nutritional information 115 to the user via the display 130. In some embodiments, DAM 155 receives the pulse count from the volumetric flow rate sensor 120 in real-time, that is, as the syrup is moving through the delivery lines and the beverage 105 is being dispensed, and continuously pushes the pulse count to the electronic device 165 at regular intervals.

For example, in one embodiment, DAM 155 regularly pushes the pulse count to the electronic device 165 every 500 μs, and the electronic device 165 continuously calculates a running total of the nutritional information 115 for the beverage 105. In this configuration, the display 130 presents the nutritional information 115 to the user in real time as the user is receiving the beverage 105. For example, as the beverage 105 is being dispensed, the calorie readout 185 of the dial gauge 175 continuously increases from 0 and the border 180 around the dial gauge 175 is continuously illuminated. By monitoring the dial gauge 175, the user can determine in real time the nutritional information 115 of the beverage 105 as it is dispensed so that the user can determine when to stop the beverage 105 from being dispensed into the user's cup 150. For instance, if the user wants to ensure that the beverage 105 contains no more than a desired amount of calories (or sugar, sodium, etc.), the user can select the beverage 105 and monitor the dial gauge 175 as it approaches the selected calorie benchmark. As the dial gauge 175 approaches the calorie benchmark, the user can determine when to remove the cup 150 so that the beverage 105 contains the desired calories (or other nutritional variable).

Preferably, DAM 155 transmits the pulse count to the electronic device 165 in less than 1 ms to reduce or eliminate visible lag time in presenting the information to the user, but in other embodiments, other transmission speeds slower than 1 ms may be used. Alternatively, in other embodiments, DAM 155 and/or electronic device 165 may instead delay the calculation of the nutritional information 115 until the user has received a desired amount of the beverage 105. At that point, DAM 155 counts the pulses generated by the flow sensor 120 and transmits the pulse count to the electronic device 165 for calculation of the nutritional information 115.

In some embodiments, in addition to displaying nutritional information 115, electronic device 165 may also display marketing content and advertisements to the user, such as via a marketing window 170. The marketing content may be directly related to the brand or brand family of beverage 105 selected by the user (such as other product lines by the same company for the selected beverage 105), or may be related to the venue or location of the system 100 (such as displaying advertisements for retail establishments, restaurants, and other businesses/services located near the vicinity of the system 100).

In some embodiments, one or more of DAM 155, electronic device 165, or another storage device (e.g., a hard drive, removable media drive, cloud services, wireless networks) may store stock marketing content and a processor or other management device selects specific marketing content for display on electronic display 130, or the marketing content may simply cycle at predetermined intervals. Preferably, when the system 100 is idle (e.g., no user has selected a beverage), the marketing window 170 (or a larger portion of the electronic display 130) may act as a digital signage tool for continuously display marketing content.

Similarly, one or more of DAM 155, electronic device 165, or another storage device may record usage data for the dispensed beverages (e.g., record the user's selections and volume of beverages being dispensed) and regularly port that data to another device, such as for inventory management and logistics.

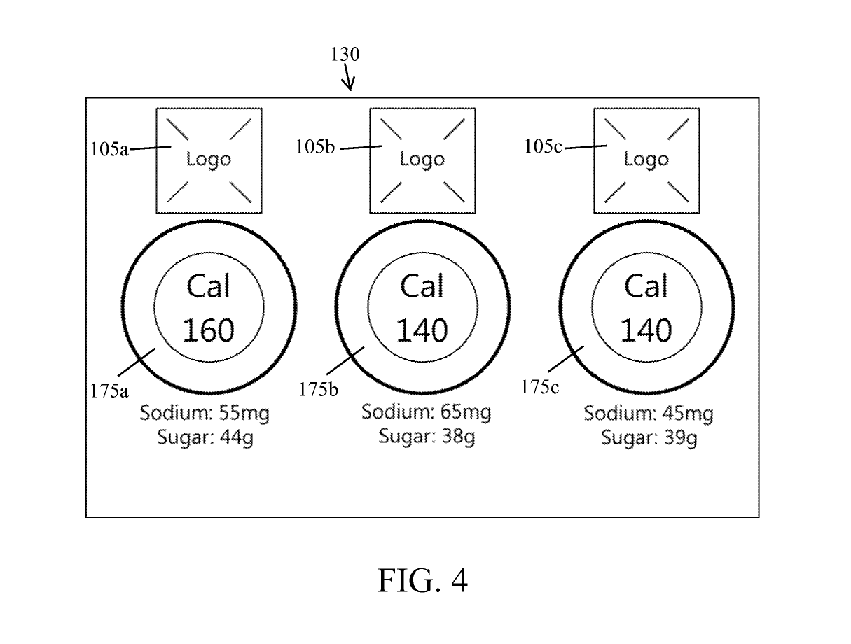

FIG. 4 illustrates another example graphical user interface of the display 130. In some embodiments, the system 100 may accommodate multiple users, such as when two or more users are receiving different beverage selections simultaneously. In such embodiments, the display 130 may compartmentalize and present the nutritional information to the user for each beverage 105a, 105b, 105c, such as via dial gauges 175a, 175b, 175c, respectively. The user may review the logos or identification for the dispensed beverage (e.g., 105a) to identify his or her selection and view the associated dial gauge (e.g., 105a) to review nutritional information for the beverage.

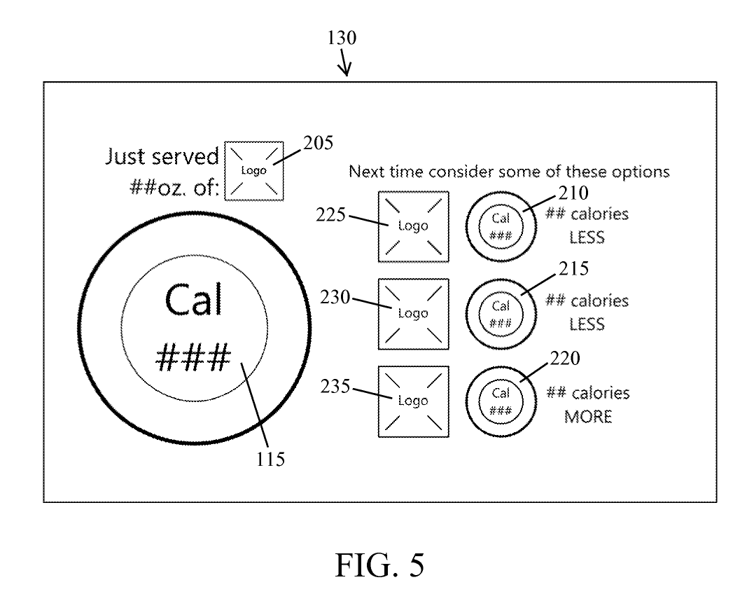

FIG. 5 illustrates another example graphical user interface of the display 130. In some embodiments, the display 130 may present to the user the nutritional information 115 relating to the dispensed beverage 105, and also present to the user nutritional information for other non-selected beverages so that the user can compare the selected beverage 105 with other available options. With particular reference to FIG. 5, the display 130 may present the nutritional information 115 and the brand name/logo 205 of the selected beverage 105. Based on the amount of syrup used to produce the dispensed beverage 105 (as sensed by the flow sensor 120), DAM 155 or electronic device 165 may calculate nutritional information 210, 215, 220 for other brands 225, 230, 235 of available beverages, and present the data to the user for evaluation. The user thereafter may review the information and determine if the nutritional information 115 of the selected beverage 105 is suitable for consumption. If the user determines that a different selection (e.g., one of the other options presented) may better serve his or her dietary needs, the user may empty the cup 150 and select a different beverage. Alternatively, the user may remember the information and may select a different beverage at a later time.

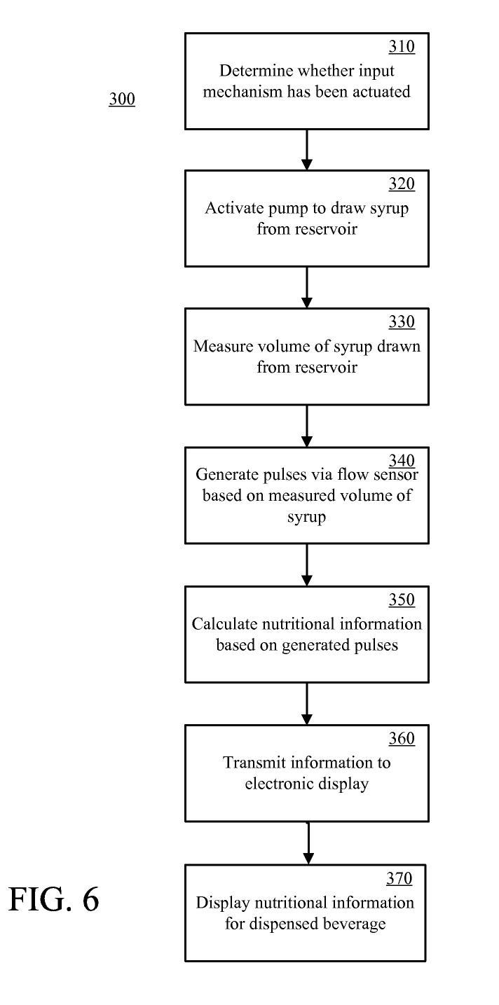

FIG. 6 is a flowchart of an example method 300 that may be performed by the real-time consumption system 100, according to one embodiment. With reference to FIG. 6, the system 100 at step 310 determines whether the button or other input mechanism 140 on the soda fountain 110 has been actuated, indicating that a user has made a selection for a beverage 105. In some embodiments, the soda fountain 110 may not include manually actuatable buttons 140, but may instead include a touchscreen display presenting the user with a menu of options for selection of a beverage 105. It should be understood that in other embodiments, other suitable selection methods may be used.

In response to actuation of the input mechanism 140, the system 100 at step 320 activates the syrup pump 135 to draw syrup from the syrup reservoir 125 for the selected beverage 105. As the syrup is drawn out, at step 330, the flow sensor 120 measures the volume of syrup drawn from the reservoir 125 and carried toward the soda fountain 110 for dispensing to the user. At step 340, the flow sensor 120 generates electrical pulses that are counted by DAM 155. At step 350, DAM 155 calculates nutritional information 115 based on the number of electrical pulses received from the flow sensor 120. As mentioned previously, each electrical pulse communicates to DAM 155 a predetermined volume of syrup sensed by the flow sensor 120. In some embodiments, at step 350, DAM 155 may also calculate nutritional information for various non-selected beverages available to the user for comparison purposes as described with reference to FIG. 5.

For example, in one embodiment, the flow sensor 120 may generate an electrical pulse for every mL of syrup. Accordingly, if the flow sensor 120 generates a total of five electrical pulses for a selected beverage 105, DAM 155 will calculate the nutritional information 115 for the beverage 105 based on the 5 mL of syrup contained in the dispensed beverage 105. Typically, since the diluting agent 160 (e.g., carbonated water) in the beverage 105 has no or negligible amounts of calories, sugar, or sodium, the calculation based solely on the amount of syrup in the beverage 105 accurately represents the nutritional information 115 in the beverage 105.

In other embodiments, such as where the diluting agent 160 may affect the calculation of the nutritional information 115, the system may be adapted to include a flow sensor (e.g., flow sensor 120) in communication with the delivery line of the diluting agent 160. In such embodiments, the flow sensor may measure an amount of the diluting agent 160 and generate electrical pulses to communicate to DAM 155 the amount of diluting agent 160 contained in the beverage 105. DAM 155 may then carry out a similar calculation as described previously to calculate the nutritional information 115 in the beverage 105.

At step 360, DAM 155 pushes/transmits the calculated nutritional information 115 to the electronic device 165. Preferably, DAM 155 wirelessly communicates with electronic device 165, but as mentioned previously, DAM 155 and electronic device 165 may also be hardwired. After receiving the data, at step 370, electronic device 165 presents the nutritional information 115 to the user for review via the display 130.

In other embodiments, step 350 may be performed by electronic device 165 based on the pulse count recorded and transmitted by DAM 155. At step 360, electronic device 165 may thereafter transmit the calculated information to the display 130 for presentation to the user.

It should be understood that in other embodiments, certain components of the system 100 may be combined in various ways to achieve some or all of the advantages of the described embodiments. For instance, in another embodiment (not shown) the volumetric flow rate sensor 120 may be omitted and the pump, such as a positive displacement pump, may instead incorporate a sensor or other sensing mechanism, where the sensor measures the number of strokes of the pump, or the position of a piston within the cylinder, and communicates the stroke count or piston position to DAM 155. Since each pump stroke draws a certain amount of syrup from the syrup reservoir 125, by tallying the stroke count or monitoring the position of the piston or diaphragm of the pump, DAM 155 (or electronic device 165) may be able to calculate the nutritional information 115 of the dispensed syrup using the total pump stroke count. In such embodiments, each conduit or syrup line (such as for soda machines with multiple beverage options) may no longer need an individual flow rate sensor since the sensor mechanism in the pump measures pump stroke count or position to determine the dispensed volume of syrup from the syrup reservoir.

In another embodiment, the volumetric flow rate sensor 120 may be omitted and a weight sensor or other scale mechanism may be attached to or used in conjunction with the syrup reservoir 125. In such embodiments, the weight sensor is operable to weigh the amount of syrup in the syrup reservoir 125. Subsequently, such as after activation of the syrup pump 135, the weight sensor measures the change in weight of the syrup reservoir 125 as syrup is drawn from the reservoir 125 to create the beverage 105. The weight sensor may measure the weight continuously, or after the beverage 105 is dispensed, and communicate that weight change of the syrup reservoir 125 to DAM 155. DAM 155 (or electronic device 165) may calculate a volume of syrup dispensed based on the weight measurements determined by the weight sensor. With this information, DAM 155 (or electronic device 165) may calculate the nutritional information 115 in a similar fashion as described previously.

In another embodiment, the volumetric flow rate sensor 120 may be omitted and the DAM 155 (or electronic device 165) may be configured to calculate the nutritional information 115 of the dispensed syrup by measuring the time the button 140 is depressed or another input mechanism actuated (e.g., selecting a beverage 105 on an electronic display). The DAM 155 (or electronic device 165) may use a known flow rate and multiple that value by the time the button 140 is depressed or another input mechanism actuated. The DAM 155 (or electronic device 165) may sense the valve position or monitor the mechanism that activates the valve which may be located within the soda fountain 110.

Other embodiments are possible. Although the description above contains much specificity, these details should not be construed as limiting the scope of the invention, but as merely providing illustrations of some embodiments of the invention. It should be understood that subject matter disclosed in one portion herein can be combined with the subject matter of one or more of other portions herein as long as such combinations are not mutually exclusive or inoperable.

The terms and descriptions used above are set forth by way of illustration only and are not meant as limitations. It will be obvious to those having skill in the art that many changes may be made to the details of the above-described embodiments without departing from the underlying principles of the invention.

1. A system for providing nutritional information of a beverage dispensed by a beverage dispenser, the system comprising:
a sensor in communication with a syrup reservoir of the beverage dispenser, the sensor configured to measure an amount of syrup dispensed from the syrup reservoir and contained in a dispensed beverage, the sensor further configured to generate a signal corresponding to the measured amount of syrup;
a controller in communication with the sensor, the controller configured to receive the signal from the sensor and calculate nutritional information for the measured amount of syrup in the dispensed beverage; and
an electronic display in communication with the controller, the electronic display configured to receive the nutritional information from the controller and display the nutritional information for the dispensed beverage.

2. The system of claim 1, wherein the sensor is in communication with a conduit extending from the syrup reservoir to an output nozzle, the conduit carrying the syrup dispensed from the syrup reservoir.

3. The system of claim 2, wherein the sensor is a flow-rate sensor measuring a flow rate of the syrup passing through the conduit.

4. The system of claim 3, wherein the signal generated by the flow-rate sensor is an electrical pulse based on the amount of syrup sensed by the flow-rate sensor.

5. The system of claim 4, wherein the controller calculates the nutritional information of the dispensed beverage based on the electrical pulses.

6. The system of claim 1, further comprising an electronic device in communication with the controller, wherein the electronic display is integrated with the electronic device.

7. The system of claim 1, wherein the nutritional information of the dispensed beverage includes at least one of: caloric content, sugar content, or carbohydrate content.

8. The system of claim 1, wherein the electronic display is further configured to display advertisements.

9. The consumption system of claim 1, wherein the controller is further configured to calculate nutritional information for a non-dispensed beverage based on an amount of syrup for the non-dispensed beverage equal to the measured amount of syrup in the dispensed beverage, and wherein the electronic display is further configured to display the nutritional information for the non-dispensed beverage together with the nutritional information for the dispensed beverage.

10. A beverage dispensing system, comprising:
a first reservoir for storing syrup;
a second reservoir for storing a diluting agent;
an input mechanism;
a dispenser in communication with the first and second reservoirs and the input mechanism, the dispenser dispensing a beverage containing a mixture of the syrup and the diluting agent in response to activation of the input mechanism;
a sensor in communication with the first reservoir, the sensor measuring an amount of syrup dispensed from the first reservoir and contained in the dispensed beverage;
a controller in communication with the sensor, the controller receiving data from the sensor relating to the measured amount of syrup, the controller calculating nutritional information for the dispensed beverage based on the measured amount of syrup; and
an electronic display in communication with the controller, the electronic display receiving the nutritional information from the controller and displaying the nutritional information to provide real-time nutritional information to a user regarding the dispensed beverage.

11. The dispensing system of claim 10, further comprising a conduit in fluid communication with the first reservoir, wherein the sensor is in communication with the conduit.

12. The dispensing system of claim 11, wherein the sensor is a flow-rate sensor measuring a flow rate of the syrup passing through the conduit in response to activation of the input mechanism.

13. The dispensing system of claim 12, wherein the flow-rate sensor generates an electrical pulse based on the amount of syrup dispensed from the first dispenser, and wherein the controller calculates the nutritional information of the dispensed beverage based on the electrical pulse.

14. The dispensing system of claim 10, further comprising a wireless network in communication with the controller and the electronic display, the wireless network configured to transmit a signal from the controller to the electronic display, the signal including data relating to the nutritional information of the dispensed beverage.

15. The dispensing system of claim 10, wherein the nutritional information of the dispensed beverage includes at least one of: caloric content, sugar content, sodium content, caffeine content, or carbohydrate content.

16. The dispensing system of claim 10, wherein the electronic display includes a touch screen display, and wherein the input mechanism is a user-selectable menu button on the touch screen display.

17. The dispensing system of claim 10, wherein the electronic display is further configured to display advertisements.

18. The dispensing system of claim 10, wherein the controller is further configured to calculate nutritional information for a non-dispensed beverage based on an amount of syrup for the non-dispensed beverage equal to the measured amount of syrup of the dispensed beverage, and wherein the electronic display is further configured to display the nutritional information for the non-dispensed beverage together with the nutritional information for the dispensed beverage.

19. A method for displaying nutritional information of a beverage dispensed by a beverage dispensing system, the method comprising:
measuring, via a sensor, an amount of syrup dispensed from a syrup reservoir of the beverage dispensing system and included in a dispensed beverage;
generating, via the sensor, a signal based on the measured amount of syrup;
receiving, via a controller, the signal generated by the sensor;
calculating, via the controller, nutritional information relating to the measured amount of syrup in the dispensed beverage;
transmitting, via the controller, the calculated nutritional information to a display; and
presenting, via the display, the calculated nutritional information of the dispensed beverage.

20. The method of claim 19, further comprising:
calculating, via the controller, nutritional information for a non-dispensed beverage based on an amount of syrup of the non-dispensed beverage equal to the measured amount of syrup of the dispensed beverage; and
presenting, via the display, the calculated nutritional information for the non-dispensed beverage together with the nutritional information for the dispensed beverage.
